(19) United States
(12) Patent Application Publication
(10) Pub. No.: US 2004/0046030 A1
(43) Pub. Date: Mar. 11, 2004

(54) Code reader

(75) Inventors: Tohru Okada, Aichi-gun (JP); Toshiharu Kawashima, Nishikasugai-gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN ENGINEERING CO., LTD., Kariya (JP)

(21) Appl. No.: 10/447,947

(22) Filed: May 30, 2003

(30) Foreign Application Priority Data
May 30, 2002 (JP) 2002-195252

(51) Int. Cl. G06K 7/10; G06K 15/12

(52) U.S. Cl. 235/462.41

(57) ABSTRACT

A code reader includes a housing, a reading portion, provided on the housing, for reading a code provided on an object; a device, provided in the housing, for illuminating the code a device, provided in the housing, for capturing an image of the code; the device for illuminating the code irradiating a light to the code for reading information of the code by a light reflected from the code; and a light transmission member, provided between the device for capturing the image and the reading portion, for introducing the light generated by the device for illuminating the code.

J This application is based on and claims priority under 35 U.S.C. §119 to Japanese Patent Application No. 2002-195252 filed on May 30, 2002, the entire contents of which are incorporated herein by reference.

### FIELD OF THE INVENTION

The present invention relates to a code reader. More specifically, the present invention pertains to an internal construction of a code reader for reading a unique or identical code (i.e., information such as a one-dimensional code, a two-dimensional code, a three-dimensional code, and a hybrid multi-dimensional code combining different codes that show the information for an object) based on a reflection of irradiated light from the code. The reflection is obtained by irradiating the light from a light source relative to the code provided on the object.

### BACKGROUND OF THE INVENTION

In order to control particular objects (e.g., products) each object is provided with a code (e.g., a one dimensional code or two dimensional code showing the information identifying the product) for differentiating each product. By reading the code provided on the particular product with a code reader, the product may be comprehensively controlled for purposes such as inventory or the like.

A code reader is described in Japanese Patent Laid-Open Publication No. 2000-29979. The code reader described in Japanese Patent Laid-Open Publication No. 2000-29979 includes a light source provided facing opposite side from an opening of a hood portion for performing code reading of two-dimensional code. A surface to be read provided with the two-dimensional code is irradiated with the indirect illumination. The reflective light reflected from the two-dimensional code is then detected by a two-dimensional sensor via a lens.

Another code reader is described in Japanese Patent No. 2780146. With the code reader described in Japanese Patent No. 2780146, a lens, a sensor, and light sources are accommodated in a body case. A light entrance diaphragm mechanism is provided on a reading side of the lens, the light source is irradiated to a surface of the light entrance diaphragm mechanism, and a surface of an incident light diaphragm has a camouflaged color (i.e., the surface has a color that reflects light, for example, the color white), which enables the diffusion of the light.

With the code reader described in Japanese Patent Laid-Open Publication No. 2000-29979, in which the surface to be read is illuminated by the indirect illumination, the strength of light becomes attenuated during light reflection. Thus, the luminance on the surface to be read is somewhat decreased as compared to the luminance of the light source. In this case, in order to brightly illuminate the surface to be read, light sources with high luminance must be employed, or the output must be improved by changing a drive circuit of the light source. This leads to drawbacks, such as increasing the manufacturing cost and complicating the construction of the code reader.

In Japanese Patent No. 2780146, the light entrance diaphragm mechanism is coated with a paint having a color such as white, so that the light entrance diaphragm mechanism has a camouflaged color. This camouflaged color improves performance of indirect illumination by effectively reflecting the light from the light source with the light entrance diaphragm mechanism. However, when a white color is used for the coating, the white color may become yellowish by the secular change. In other words, when the color of the light entrance diaphragm mechanism becomes yellowish, the reflection rate decreases as compared to the white color, and the luminance at the surface to be read decreases.

From this description, it is evident that a need exists for a code reader capable of effectively reading a unique code without decreasing the luminance of light from a light source and that is capable of reading a unique code provided on a mirror surface.

### SUMMARY OF THE INVENTION

In light of the foregoing, the present invention provides a code reader which includes a housing; a reading portion, provided on the housing, for reading a code provided on an object; means, provided in the housing, for illuminating the code; means, provided in the housing, for capturing an image of the code; the means for illuminating the code irradiating a light to the code for reading information of the code by a reflection light reflected from the code; and a light transmission member, provided between the means for capturing the image and the reading portion, for introducing the light generated by the means for illuminating the code.

According to another aspect of the invention, a code reader includes a housing; a reading portion, provided on the housing, for reading a code provided on an object; a light source provided in the housing and configured to illuminate the code; a CCD camera provided in the housing for capturing an image of the code; the light source irradiating a light to the code for reading information of the code by a reflection light reflected from the code, and a light transmission member provided between the CCD camera and the reading portion for introducing the light generated by the light source.

### BRIEF DESCRIPTION OF THE DRAWINGS

The foregoing and additional features and characteristics of the present invention will become more apparent from the following detailed description, when considered with reference to the accompanying drawing figures, in which like reference numerals designate like elements.

FIG. 1 is an overview showing a configuration of a code reader according to an embodiment of the present invention.

FIG. 2 is a cross-sectional view on a right hand side of the x-y plane surface of the code reader shown in FIG. 1.

FIG. 3 is a cross-sectional view on a left hand side of the x-y plane surface of the code reader shown in FIG. 1

FIG. 4 is a cross-sectional view of the x-z plane surface of a hood portion shown in FIG. 1.

FIG. 5 is a view showing an internal construction from the rear of the housing of the code reader shown in FIG. 1.

FIG. 6 is a view showing an internal construction of the code reader with a main board and an optical board from FIG. 5.

FIG. 7 is a back view of the housing of the code reader shown in FIG. 1.

FIG. 8 is a side view showing a construction of an illumination unit provided in the code reader shown in FIG. 1.

FIG. 9 is a cross-sectional view in the x-y direction showing an internal construction of the illumination unit shown in FIG. 8.

FIG. 10 is an explanatory view illustrating a reading range when performing the reading of the unique code with the code reader shown in FIG. 2.

FIG. 11 is a view showing a configuration of a two-dimensional code provided on an object shown in FIG. 10.

FIG. 12 is an explanatory view showing the light irradiated from the illumination unit to a surface to be read shown in FIG. 4.

### DETAILED DESCRIPTION OF THE INVENTION

A first non-limiting embodiment of a code reader according to the present invention will be explained with reference to the illustrations of the figures.

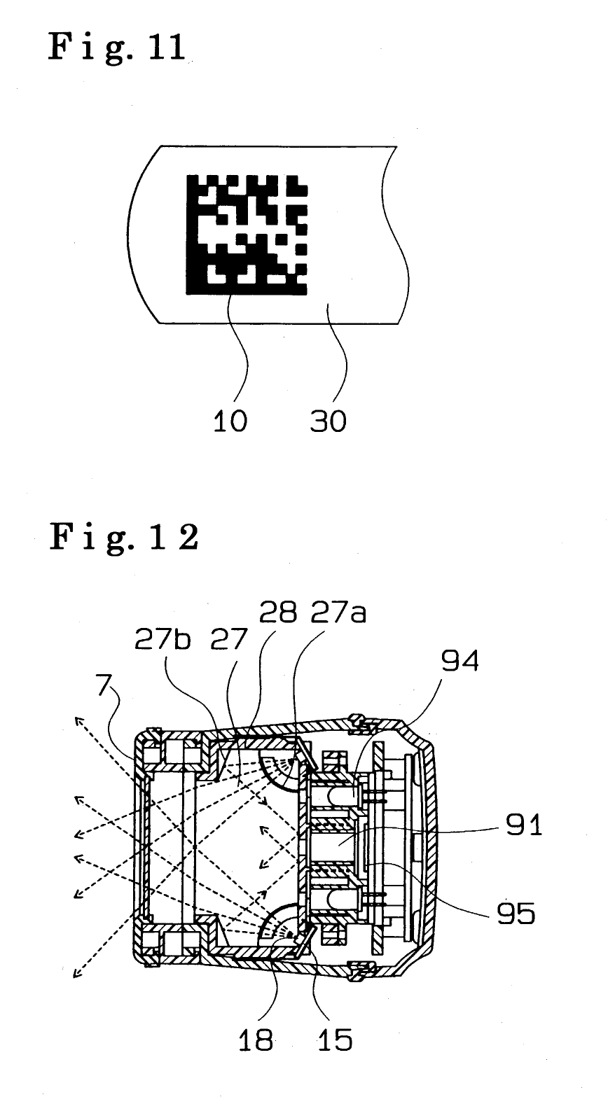

A code reader 1 may be configured to read the information unique to an object 30 from a code 10 (e.g., one dimensional code, two dimensional code, three dimensional code, or multi-dimensional code combined with different codes, hereinafter referred to as a code) by providing the code 10 directly or indirectly on the object to identify the particular object 30 (shown in FIG. 11, for example) among plural objects made of metal, rubber, ceramic, resin, and the like. With the code reader according to this non-limiting embodiment, a two dimensional code is applied and the code reader 1 for reading the information shown with the two-dimensional code will be explained.

Although the following description relates to a two-dimensional code, it is important to note that the code is not limited to the two-dimensional code, and members printed or inscribed with codes such as (but not limited to) a one dimensional code, a three-dimensional code, or a multi-dimensional code represented as a barcode are applicable to a device for reading the code 10 (more specifically, the information shown with the code) by the reflective wave of the light reflected from the code 10. The reflective wave is obtained by irradiating the light from the inside of the code reader 1 to the particular portion having the code 10.

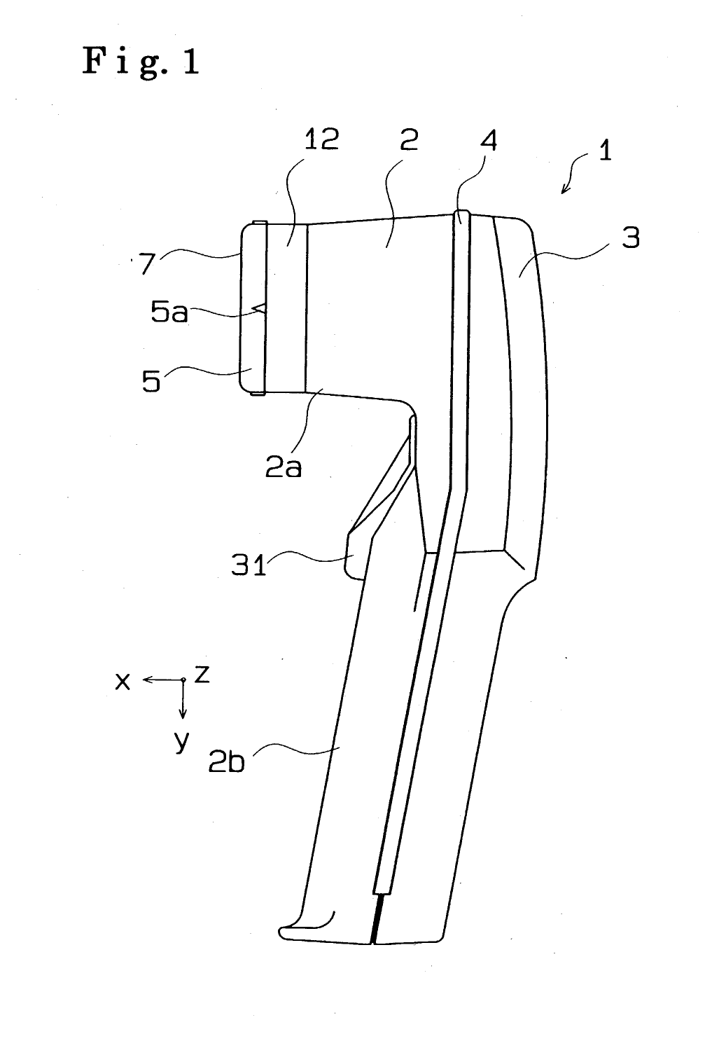

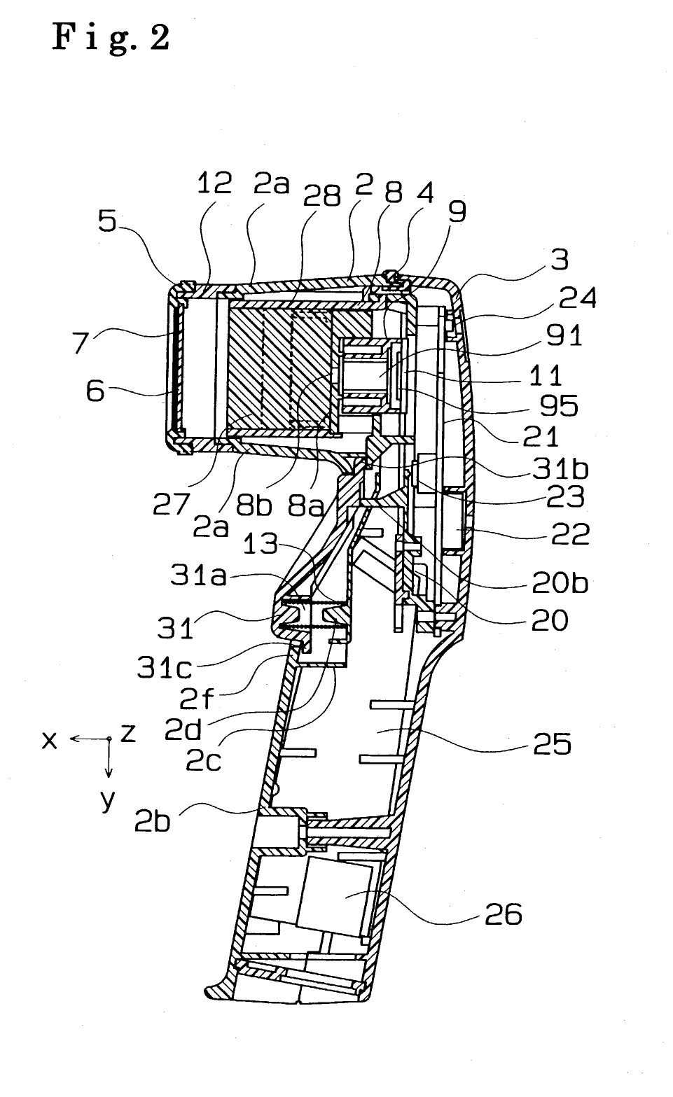

With the present non-limiting embodiment of the code reader, a light axis direction perpendicular to a CCD (charge coupled device) element included in a CCD camera 95 and lens group 91 (shown in FIG. 2) is determined to be an X-axis direction. A direction perpendicular to the X-axis is determined to be a Y-axis direction, and a direction perpendicular to the X-axis and the Y-axis is determined to be a Z-axis direction. Further, the top FIG. 1 is determined to be a top of the code reader, the bottom of FIG. 1 is determined to be a bottom of the code reader 1, and the right side of FIG. 1 is determined to be a back surface of the code reader 1.

As shown in the non-limiting illustration of FIG. 1, the code reader 1 may include a first housing 2 and a second housing 3 made of resin or the like. Non-limiting examples of a suitable material include ABS resin and urethane. The first housing 2 is formed with an opening on the back surface (i.e., at the right side of FIG. 1) and the opening is covered with the second housing 3 having a recessed configuration. The top of the reader of the first housing 2 is unitarily formed with a hood portion 2a having an approximately rectangular configuration projected in the X-direction. A grip portion 2b is formed to be extended at a slight angle from the Y-axis shown in FIG. 1 from the hood portion 2a of the first housing 2. The first and the second housings 2 and 3 may be assembled for covering the openings, respectively, and may be fixed to each other with tightening members such as screws or the like.

The code reader 1 may include an operation lever 31, provided between the hood portion 2a and the grip portion 2b of the housing 2, and rotatable about the Z-axis. By the operation of the operation lever 31 by a user, the code reader 1 is activated to read the code 10 provided on the object 30.

When the first and the second housings 2, 3 are assembled to be fixed, a slip stopper 4 made of, for example, rubber or elastomer or the like may be provided, and may be configured to correspond to the opening configurations of the housings 2, 3. The slip stopper 4 may be secured to the first and the second housings 2, 3, along the configuration of the opening end portions of the housings 2, 3 (provided between the housings 2, 3). The slip stopper 4 prevents a user's hand from slipping from the grip portion 2b when the user operates the operation lever 31 of the code reader 1 for reading the code 10.

Referring to FIG. 2, the internal construction of the code reader 1 will be explained. The hood portion 2a of the housing 2 opens in the X-direction. An adjusting member 12 for optically adjusting the reading distance may be fitted at an end of the opening of the hood portion 2a. The adjusting member 12 is configured to correspond with the end of the opening of the hood portion 2a, and may be made of the same material as the housing 2. A hood cover (i.e., a cap) 5 may include a light permeation plate. For example, the light permeation plate may include transparent or semi-transparent glass, plastic, or the like processed as an optical filter. The light permeation plate functions as an optical filter for blocking ultraviolet rays and infrared rays, and may be provided on a tip end of the adjusting member 12. The hood cover 5, made of rubber or elastomer or the like, is provided on one end of the adjusting member 12.

Four position determination portions 5a for facilitating positioning in the Y-direction and the Z-direction between the code 10 and a surface to be read of the code 10 may be formed unitarily on the hood cover 5. The position determination portion 5a may have a triangular configuration at the center in the Y-direction and the Z-direction of the hood cover 5 having approximately rectangular configuration. A surface covered with the hood cover 5 corresponds to a reading portion 7 for reading the code 10 and a surface to be read is located outside the reading portion 7. In the hood portion 2a, an illumination unit 8 configured to illuminate the surface to be read may be provided in an inner part of the reading surface 7.

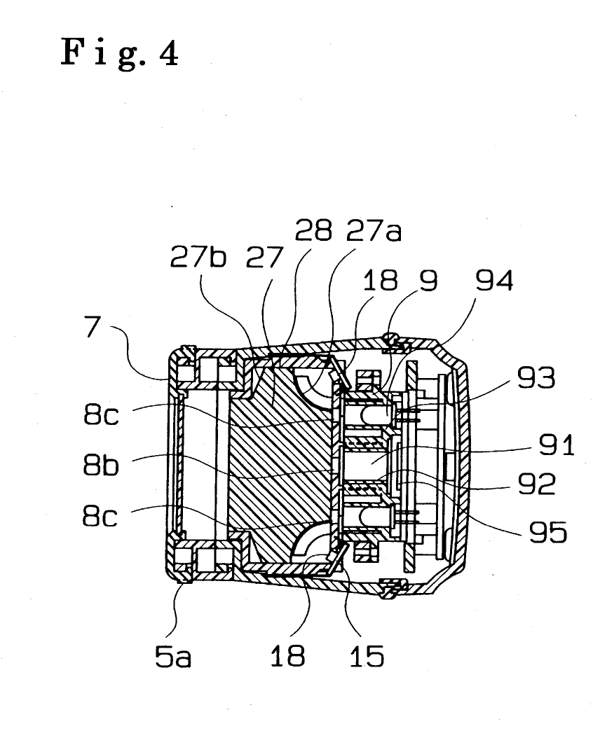

The illumination unit 8 having a box shape with a bottom may be made of resin or the like. The illumination unit 8 includes at least one light source therein for illumination (e.g., an LED for illumination) 18 for illuminating the entire illumination unit by irradiating the colored light (e.g., red) when reading the code (as shown in FIG. 4). The illumination unit 8 includes a light transmission member 27, being made of a material that preferably prevents distortion of the light, such as glass or transparent resin (for example, an acryl type resin). The light source 18 for the illumination may have a predetermined irradiation angle (e.g., 60 degrees) configured to irradiate the light from the diagonal direction to the light axis X, and may be provided on both ends of a back surface side of the rectangular shaped illumination unit 8.

The light transmission member 27 may be formed by cutting the transparent rectangular block and grinding the surface thereof as shown in FIG. 4. A curved recess portion extended in the Y-direction may be formed on both ends of the back surface side of the light transmission member 27 in the Z-direction, respectively. The curved recess portions correspond to lens portions 27a for expanding the irradiated light from the light source 18, thereby enabling the illumination to achieve a diffused angle, relative to the inside of the light transmission member. On the other hand, a slit portion extended in the Y-direction is formed on both ends of the light transmission member 27 on the reading portion side in the Z-direction. The slit portion optically functions as a reflection surface 27b. A light reflection membrane 28 may be provided on an external peripheral surface of the light transmission member 27, except at portions corresponding to the both ends of the light transmission member 27 in the X-direction and the lens portions 27a.

As illustrated in FIG. 4, three bores 8b, 8c, 8c may be provided on the back surface of the light transmission member 27 in the X-direction. In this case, a white screen printing is provided on the back surface of the light transmission member 27, while avoiding the bores 8b, 8c, 8c. The light reflection membrane 28, positioned to surround the light transmission member 27, is provided for reducing unnecessary leakage of light to the outside of the light transmission member 27. More specifically, the light reflection membrane 28 is provided for increasing the light transmission efficiency in a predetermined direction for the illumination irradiated from the lens portion 27a. In this case, the light reflection membrane 28 may be provided by applying a metal with high reflection efficiency, for example chrome or silver or the like, and by performing the capor deposition of metal or plating.

The metal with high reflection efficiency such as chrome, aluminum, silver or the like may be applied onto the light transmission member 27. Further, a reflection tape, for example a silver tape, having a color with a high reflection rate, may be applied around the light transmission member 27. The color (e.g., silver) with a high reflection rate may be applied on internal walls of the illumination unit 8 in which the light transmission member 27 is arranged (i.e., in this case, the reflection membrane 28 is not directly provided relative to the light transmission member 27) for increasing the light transmission efficiency in the predetermined direction relative to the case providing the metal with high reflection efficiency surrounding the light transmission member 27.

With the foregoing construction, when the light is irradiated from the light source 18 for the illumination, the light enters from the lens portion 27a of the light transmission member 27, and a portion of the light is reflected relative to the internal portion of the light transmission member 27 by the reflection surface 27b, while the light is reflected by the reflection membrane 28 provided to diffuse the light generated on the both sides in the light transmission member 27. Thus, the reflected light (i.e., the diffusion light), which is hardly attenuated, is introduced to the reading portion 7 and the surface to be read, as shown in FIG. 12. For clarity, the hatching in the cross-section of the light transmission member 27 is omitted in FIG. 12.

As further illustrated in FIG. 4, a bottom portion 8a of the illumination unit 8 may be formed with a bore 8b that may function as a diaphragm relative to a CCD element for obtaining an image of a CCD camera 95. The bottom portion 8a of the illumination unit 8 may be formed to include rectangular configured slit bores 8c, 8c on both sides of the bore 8b in the Z-direction for, for example, irradiating the light relative to the surface to be read for reading the code 10 by a marker light source (i.e., a marker LED) 94. An optical unit 9, including the lens group (i.e., light axes of plural lens are identical) 91 having the plural lens in the center therein is provided on the inner part of the bottom portion 8a. The optical unit 9 may be fixed with the illumination unit 8 by tightening members, for example a screw or the like, on the back surface of the illumination unit 8.

The optical unit 9 having a cubic configuration may be made of a resin or the like. The optical unit 9 is formed with a lens bore 92 arranged with the lens group 91 in the X-direction and two light source bores 93. Each marker light source 94 is positioned in the optical bore 93 respectively. In this case, the light axis X of the lens group 91 and the CCD camera 95 are identical.

The back surface of the optical unit 9 may have a concave configuration as shown in FIG. 4. The CCD camera 95 having a CCD element therein may be provided in the concave portion. An optical board 11 mounted with the CCD camera 95 on the surface may be fixed to the optical unit 9 with tightening members, such as screws or the like, (not shown) from the back surface of the optical board 11 as shown in FIG. 2.

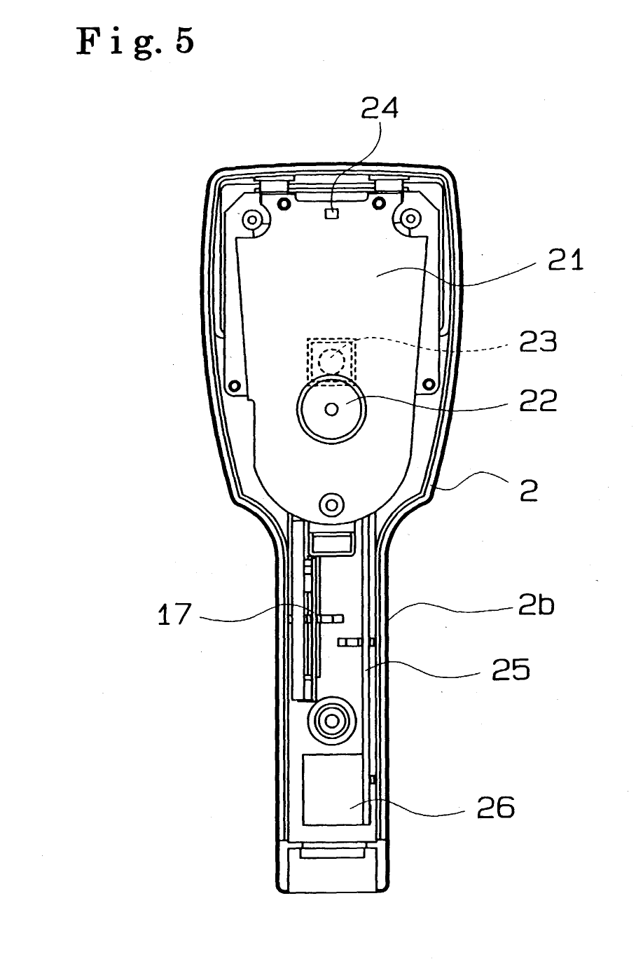

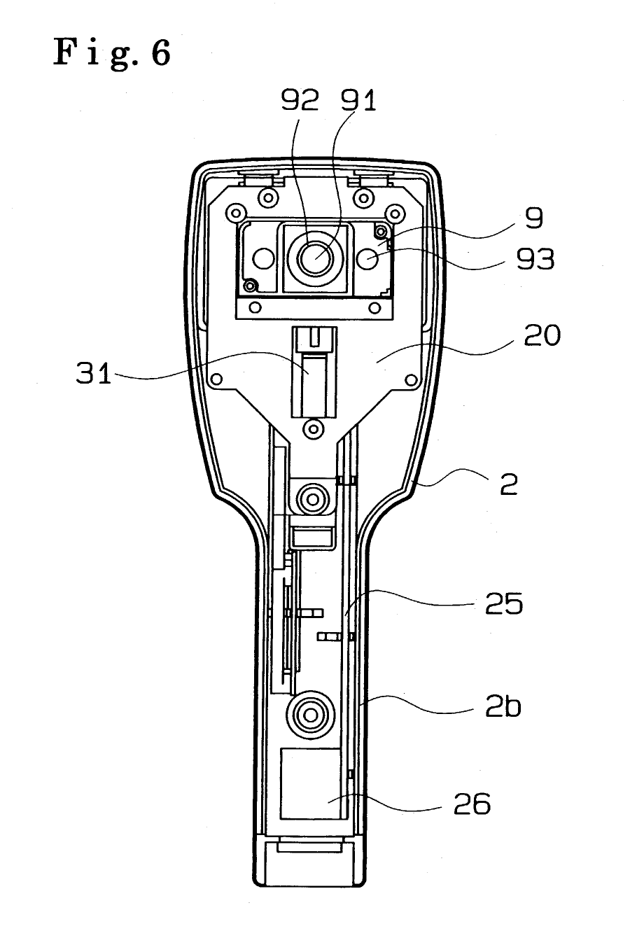

As illustrated in FIG. 4, the marker light source 94 for generating the light for indicating the reading position from two positions may be attached to the optical board 11. The optical board 11 may be mounted with electronic parts such as a chip shaped transistor, resistors, and a condenser for constructing a drive circuit and detection circuit of the CCD camera 95, and a driver circuit for driving the marker light source 94. The optical board 11 illuminates the marker light source 94 and outputs a detection signal regarding the code reading from the image imaged on the CCD element by driving the CCD camera 95. The optical board 11 may be connected with a harness configured to be electrically connected with a main board 21 as shown in FIG. 5. The detection signal related to the code reader from the optical board 11 is transmitted to the main board 21, and the signal from the main board 21 drives the marker light source 94 and the CCD camera 95.

As shown in FIGS. 2 and 5, the main board 21 is positioned on the most back surface of the housing 2 for controlling the code reading of the coder reader 1. A voltage buzzer 22 and a light source 24 for confirmation (i.e., green LED for confirmation) 24 for visually indicating the completion of the reading may be mounted on the back most side of the main board 21 by soldering or the like. A contact switch 23 may be mounted on the other side of the main board 21 by soldering or the like. Further, the main board 21 may include chip shaped electronic parts such as transistors, resistors, and condensers on both surfaces thereof and may include a decoder circuit for decoding a detection signal by the CCD element from the optical board 11, a drive circuit for driving the voltage buzzer 22, and a drive circuit for driving the light source 24 for the confirmation of the reading.

Further, a central processing unit (CPU) (not shown) for controlling the code reading of the code reader 1 and a memory (not shown) for storing (either permanently, semi-permanently, or temporarily) the information regarding the code reading may be mounted on the surface of the main board 21 on an optical board side. The main board 21 may be electrically connected to the opposingly arranged optical board 11 via, e.g., a flat cable. In the main board 21, the code 10 read by the CCD camera 95 may be decoded by a decode circuit (not shown) therein. The decoded signal may be transmitted to an interface board 25 provided in the grip portion 2b shown in FIG. 2.

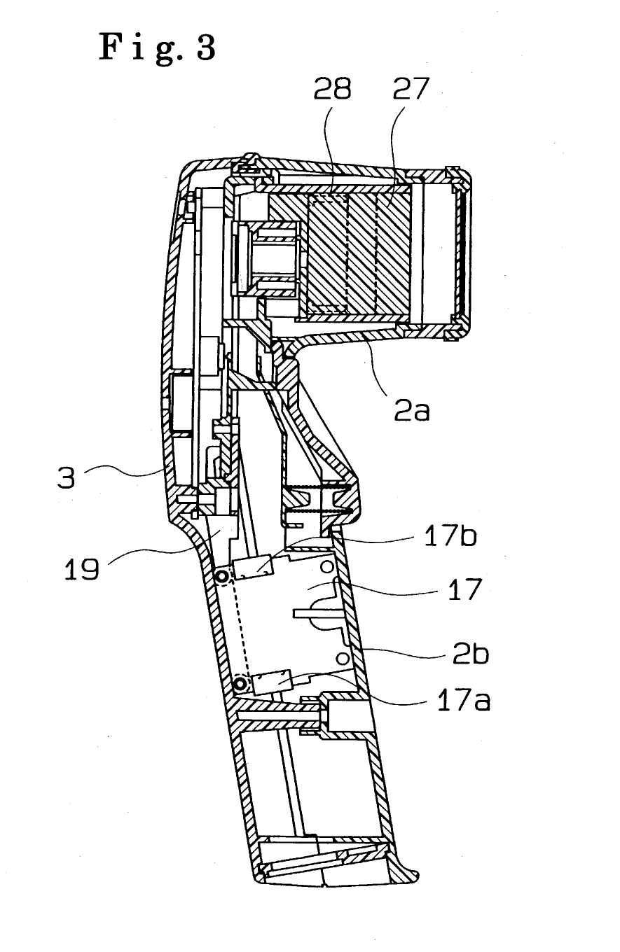

The signal for driving the light source 18 provided in the illumination unit 8 may be driven by a light source drive board 17 provided in the grip portion 2b, as shown in FIG. 3. In this case, the light source drive board 17 for the illumination is driven by the direction from the main board 21.

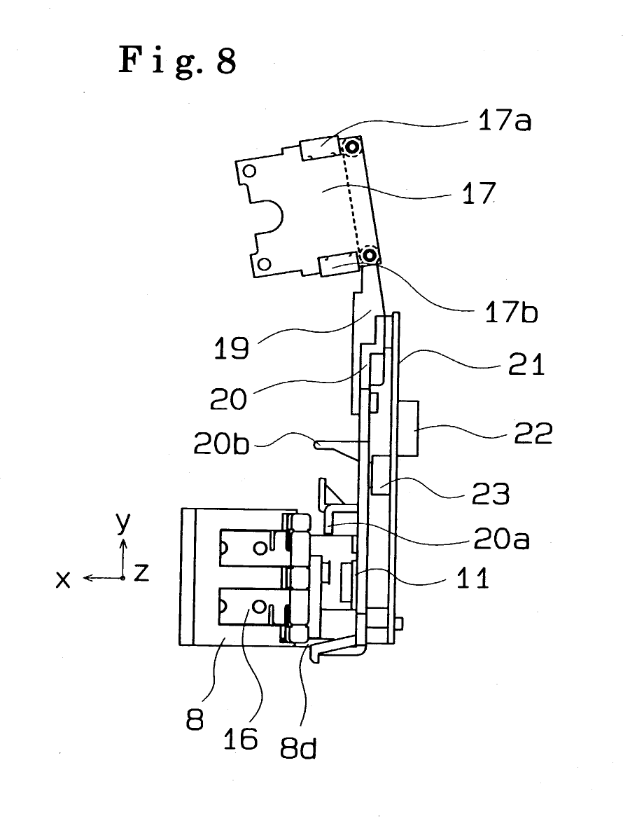

The main board 21, the optical board 11, the optical unit 9, and the illumination unit 8 are formed as one unit by, for example, a resin-made holder 20 as shown in the non-limiting illustration of FIG. 8. The holder 20 may be provided at a predetermined position of the first housing 2 from the back surface of the first housing 2 to be fixed to the first housing via four tightening members, such as screws or the like. The holder 20 may be extended in the Y-direction. A rectangular detent bore may be unitarily formed on the holder 20 on an end portion of the holder 20 corresponding to the top of the reader (i.e., bottom side in FIG. 8). An L-shaped craw portion 8d formed on the top of the reader of the illumination unit 8 may be detained in the detent bore.

The position of the illumination unit 8 may be determined at a predetermined position of the holder 20. In order to contact the back surface of the illumination unit 8 to the holder 20 to fix thereon, an L-shaped mounting portion 20a for fixing the illumination unit 8 may be unitarily formed on the holder 20 on an end portion thereof, opposite to the craw portion 8d on an illumination unit top end. The tightening members, e.g., screws, may be applied to the mounting portion 20a from the back surface side of the holder 20 to fix the illumination unit 8 on the holder 20 on the top surface of the reader.

One end of a holder 19 may be fixed to an end portion of the bottom side (i.e., top of FIG. 8) of the holder 20 via tightening members, such as screws or the like. The light source drive board 17 having the driver circuit that may be mounted with the electronic parts such as resistors and transistors on the surface and may be fixed to the other end of the holder 19 with two tightening members, such as screws, in the Y-direction, as shown in FIG. 8. Thereafter, the light source drive board 17 for the illumination may be positioned in the internal space of the grip portion 2b of the code reader 1 to be fixed to the housing 2 by the tightening members such as screws or the like on X-Y surface. The light source drive board 17 for the illumination includes two connectors 17a, 17b on end portions thereof in the Y-direction. The connector 17a may be connected to an external connector, which is connected to the main board 20 via a harness (not shown). Thus, a light source drive signal for driving the light source 18 may be output from the main board 21 to drive the light source 18 by flashing or turning on the light source 18 to read the code 10 based on the output signal.

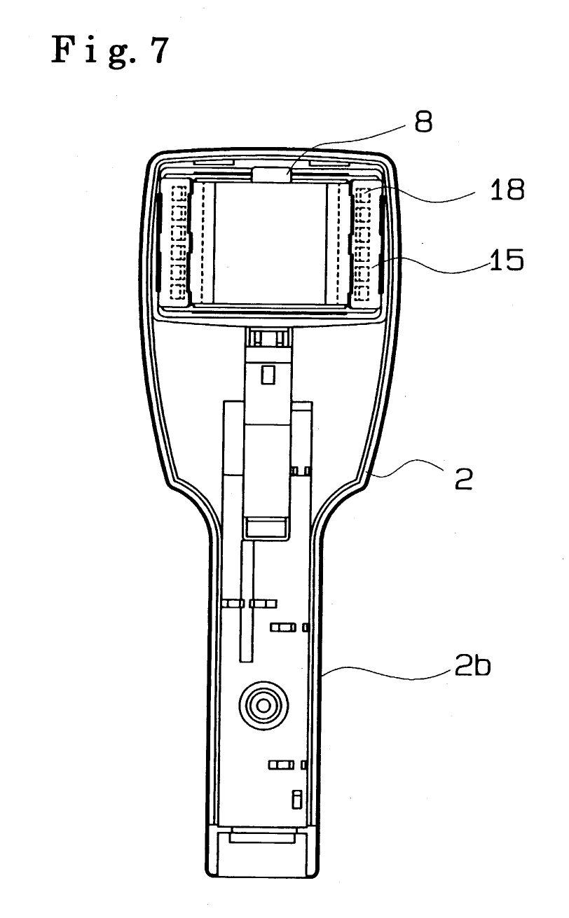

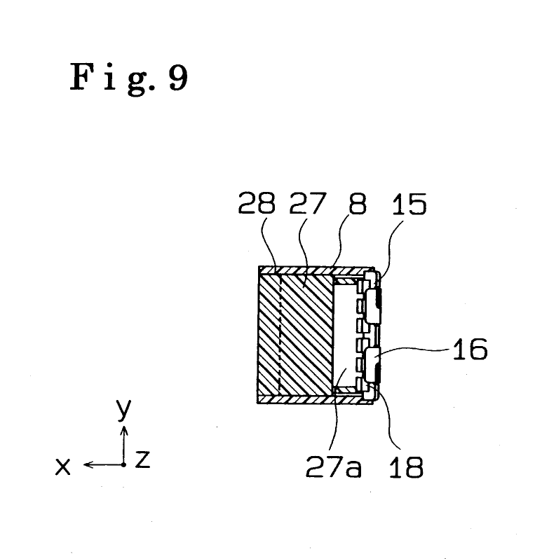

The internal construction of the illumination unit 8 will be explained with reference to FIGS. 4 and 9. As shown in FIG. 4, the illumination unit 8 may be provided on the back surface of the reading portion 7. As shown in FIG. 7, a light source board 15 may include a plurality of light sources 18 (e.g., 6 light sources on each side). The plurality of light sources 18 may be provided on both sides of the back surface of the illumination unit 8 in the Z-direction. More specifically, the light source board 15 may be provided on a tapered surface relative to both ends of the illumination unit 8 in the Z-direction so that the light is irradiated diagonally from the lens portions 27a of the light transmission member 27 provided in the illumination unit 8 to the light axis of the CCD camera 95. The plural light sources 18 may be fixed on the back surface of the illumination unit 8 via plural pawl portions.

As shown in FIG. 8, electrically conductive terminals 16 may be connected to the light source 18. The terminals 16 may be provided along a side surface of the illumination unit 8 in the Z-direction. Further, the electrically conductive terminals 16 may be electrically connected to the connector 17b of the light source drive board 17 via a harness (not shown). Thus, by providing the light source drive signal from the main board 21, the light source 18 can be turned on or flashed with a predetermined cycle when performing code reading.

Alternatively, a switch operation portion 20b may be projected in the X-direction on the middle portion of the holder 20 extended in the Y-direction. The switch operation portion 20b may be unitarily formed with the holder 20 while being movable in the X-direction. When the illumination unit 8 is unitarily provided (i.e., under a subassembly state), the switch operation portion 20b may be projected in the X-direction perpendicularly from the holder 20 as shown in FIG. 8. With the foregoing construction, the contact switch 23 may be pushed by the back surface of the switch operation portion 20b when the switch operation portion 20b is operated. Thus the turning on and the turning off of the contact switch 23 is performed. In this case, the code 10 may be read by the code reader 1 when the contact switch 23 is ON and the reading of the code 10 is prohibited when the contact switch 23 is OFF.

The operation of the operation lever 31 will be explained as follows. When the user grabs the grip portion 2b, the operation lever 31 may be operated using a finger. The operation lever may be pushed to rotate in the counterclockwise direction of FIG. 2 about a fulcrum 31b positioned around a base of the hood portion 2a. In this case, the code reader 1 is formed with a recess portion 2c having a surface extended in the Y-direction on a portion of the housing 2 opposing to the operation lever 31 so that the operation lever 31 becomes rotatable at the operation. A projection 2d projecting in the X-direction is formed unitarily on a portion of the recess portion 2c of the housing 2.

Alternatively, a concave portion 31a for detaining one end of a spring 13 may be formed on a back surface corresponding to the projection 2d of the operation lever 31. The spring may be provided between the concave portion 31a formed on the operation lever 31 and the projection 2d formed on the housing 2. A flange 31c extended in the Y-direction may be unitarily formed on the operation lever 31 on an end portion opposite to the fulcrum 31b of the operation lever 31. The flange 31c may extend along the configuration of the grip portion 2b from the grip portion 2b of the housing 2.

The rotation of the operation lever 31 may be restricted by a restriction portion 2f covering a portion of the concave portion 2c of the housing 2. Thus, the operation lever 31 may be rotated until the back surface of the operation lever 31 contacts an apex of the projection 2d when the operation lever 31 is rotated in the counterclockwise direction shown in FIG. 2 about the fulcrum 31b against the biasing force of the spring 13. The switch contact portion 20b may contact the back surface. When the operation lever 31 is operated to rotate the operation lever 31 in the counterclockwise direction, the switch operation portion 20b is pushed. Accordingly, the contact switch 23 may be turned on and the switch signal from the contact switch 23 may be input into the CPU of the main board 21.

On the other hand, when a force is not applied to the operation lever 31 after operation thereof, the operation lever 31 is rotated in the clockwise direction of FIG. 2 about the fulcrum 31b by the biasing force of the spring 13. Thereafter, the flange 31c formed on one end of the operation lever 31 may contact the restriction portion 2f of the housing 2 to restrict the further rotation of the operation lever 31 in the clockwise direction. As described above, when the rotation of the operation lever 31 in the counterclockwise direction is canceled, the pushing pressure to the contact switch 23 by the switch operation portion 20b is also canceled. Thus, the contact switch 23 turns OFF and the switch signal thereof is input into the CPU.

The connection between the code reader 1 and external device 40 will be explained as follows. As shown in the non-limiting illustration of FIG. 5, the interface board (i.e., I/F board) 25 may be fitted into a slit formed on a back surface of the housing 2 to be mounted opposing the drive board 17, while keeping a predetermined distance relative to the driver board 17 in the grip portion 2b of the code reader 1. The interface board 25 may be electrically connected to the main board 21 via a cable (e.g., a flat cable, a harness or the like, not shown). A connector 26 may be fixed to an end of the I/F board 25 on the bottom portion of the reader. The I/F board 25 may also include a power source circuit for supplying a constant direct current (e.g., 5V) relative to the plural boards of the code reader 1 therein. A circuit on the I/F board 25 may be configured to supply a stable predetermined power (e.g., 5V) to the main board 21. In case the external connector is connected to the connector 26, the date of the signal (e.g., decoded signal of the code 10 detected by the CCD camera 95) regarding the reading of the code may be sent to and received by the external device (e.g., code control device having the display function or the code analysis device) 40 connected via the connector 26. With the foregoing construction, for example, the reading signal of the code 10 decoded from a decode circuit may be output from the external device 40 to the code reader 1 and the reading signal may be sent to the external device 40.

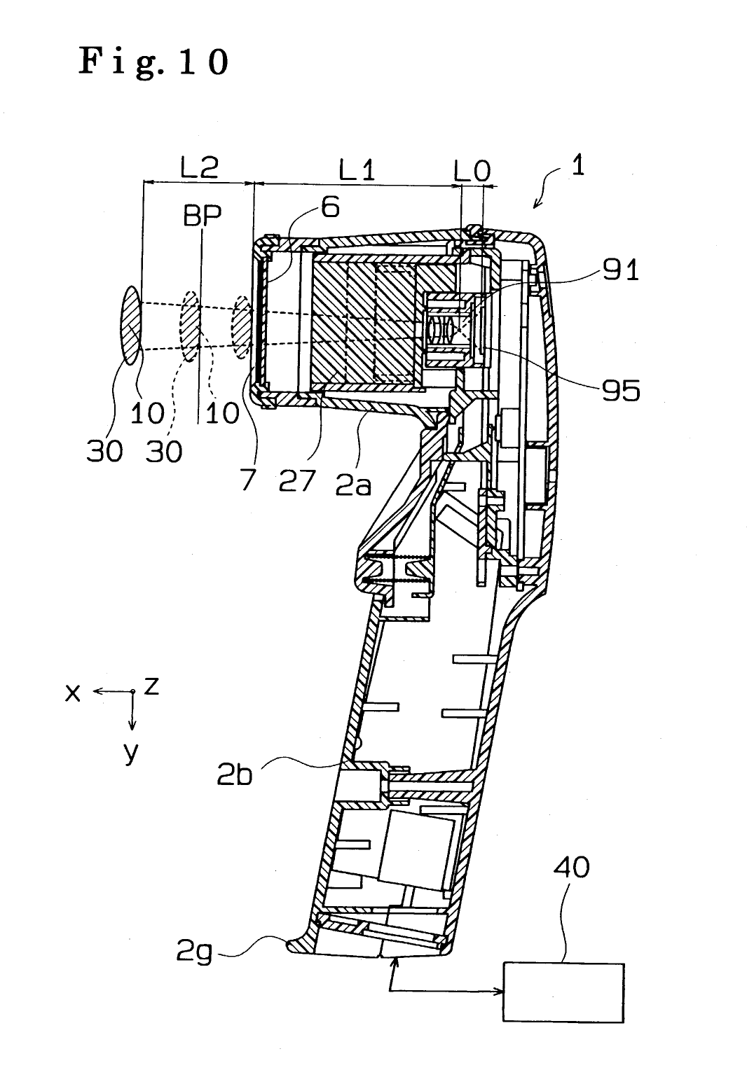

The operation of the code reader 1 will be explained with reference to FIG. 10 as follows. The code reader 1 enables reading of the code 10 (1) by directly contacting the reading portion 7 to the object 30 provided with the code or to the code 10, and (2) by keeping a distance from the surface 7 to be read without the contact to the code 10 or to the object 30 provided with the code 10. The user performing the reading of the code 10 holds the grip portion 2b of the code reader 1 and positions the code reader 1 such that the reading portion 7 is over the two-dimensional code 10. When the user pulls the operation lever 31 against the biasing force of the spring 13 from the position, the operation lever 31 rotates about the fulcrum 31b in the counterclockwise direction shown in FIG. 2. By this operation, the switch operation portion 20b may be pushed by the back surface of the operation lever 31.

Accordingly, when the switch operation portion 20b, moves in the X-direction, the contact switch 23 provided on the back surface of the switch operation portion 20b is pushed by the movement of the switch operation portion 20b to be ON. When the contact switch 23 is ON, the signal indicating the ON state may be recognized as a trigger for starting the reading by the CPU (not shown) in the main board 21. The information indicated by the code 10 may then be read as described above.

When the contact switch 23 is ON, the main board 21 is configured to simultaneously output the drive signal for driving the indirect illumination luminance 18 and the marker light source 94 to the light source drive board 17 and the optical board 11. With the light source drive signal, a pair of the light sources 18 for the illumination provided on the right and left sides of the opening of the illumination unit 8 may be simultaneously lighted or flashed, if desired. Also, the light enters from the lens portion 27a of the light transmission member 27.

The light entered to the lens portion 27a (i.e., red colored light having a predetermined irradiation angle) is introduced to the reading portion 7 for reading the code 10 (without causing attenuation) while being reflected on the reflection surface 27b formed on a portion of the light transmission member 27. The light is also reflected on the light reflection membrane 28 provided surrounding the light transmission member 27 in the transparent light transmission member 27.

Thus, a predetermined amount of the diffusion light, which is not a high quantity of light, may be generated from the reading portion 7 relative to the surface to be read to illuminate the surface to be read. Accordingly, broad light which illuminates the entire illumination unit may be created. In this case, the main board 21 simultaneously drives the marker light source 94 provided on the both sides of the CCD camera 95.

The red colored light generated from the marker light source 94 passes through the slit bores 8c, 8c formed on the bottom portion 8a of the back surface of the illumination unit 8 and the light transmission member 27, to irradiate the diffusion light to the object 30 provided with the code 10. The light contacting the code 10 is reflected (depending on the condition of the brightness of the code 10) or the roughness condition of the code 10 to enter the central bore 8b of the illumination unit 8 (having the diaphragm function) via the light transmission member 27. The light that enters into the bore 8b is imaged on the CCD element of the CCD camera 95 via the lens group 91 to be detected.

During the transmission process of the light, the reflective light reflected by contacting the code 10 transmits in the light transmission member 27. In this case, by passing through the light transmission member 27, the light is refracted by the lens effect of the light transmission member 27. Thus, the image of the code 10 based on the reflection light is enlarged by the light transmission member 27 to be imaged on the CCD element of the CCD camera 95. The light transmission member 27 may be used for the diffusion effect when the light is generated, and may also be utilized for the lens effect when receiving the light.

The signal detected by the CCD element of the CCD camera 95 is transmitted to the main board 21. The detection signal is decoded depending on the strength of the reflection light by the decode circuit in the main board 21 and the decoded signal is transmitted to the I/F circuit 25. Thereafter, the decoded signal is transmitted from the connector 26 provided on the I/F circuit 25 to the external device 40. The external device 40 controls the multiple numbers of the object 30 by displaying the read two dimensional code 10 on a display of the external device, if required, and by analyzing the information indicated by the code 10 based on the detected signal by the CCD camera 95.

The optical reading distance of the code reader 1 with the foregoing construction will be explained with reference to FIG. 10 as follows. With the present non-limiting embodiment of the present invention, the CCD camera 95 is fixed on the optical board 11 assembled on the back surface of the optical unit 9. With the construction shown in FIG. 10, the light axis X of the CCD camera 95 and the light axis X of the lens group 91, including the plural lenses, therein may be identical.

Provided that a distance between the CCD camera 95 and a camera focus point Pf is determined as a distance L0 and a distance between the focus point Pf and a tip end of the reading portion 7 is determined as a distance L1, an adjusting member 12 is provided between the hood portion 2a and the hood cover 5 for maintaining a light permeable board 6 functioning as the optical filter so that the distance L1 corresponds to a minimum recognition distance for recognizing the object to be read (i.e., two-dimensional code) on the surface to be read and for imaging the image on the CCD element of the CCD camera 95. The minimum recognition distance may be otherwise replaced by a distance subtracting a predetermined value from the minimum recognition distance (i.e., minimum recognition distance−predetermined value) or a distance added with a predetermined value to the minimum recognition distance (i.e., minimum recognition distance+predetermined value). The predetermined value may be determined as several millimeters, based on the tolerance of the CCD element, the assembling tolerance of the CCD element, the assembling tolerance of the optical board 11 and the holder 20, the tolerance of the lens group 91, the tolerance of the lens group 91 and the holder 20, and the accumulated tolerance (such as the accumulated tolerance of the holder 20 and the optical board 11).

In other words, the reading operation of the code reader 1 may be easily performed by a user who is not familiar with the operation thereof by contacting the reading surface of the code reader 1 on the code 10. In this case, by slightly projecting an end portion 2g of the grip portion 2b of the code reader 1 in the X-direction, the reading operation of the code 10 can be performed only by the operation of the operation lever 31 without holding the code reader 1 while contacting both the end portion 2g of the grip portion 2b and the end portion of the reading portion 7 to either to the object 30 or a base provided with the object 30. Even when the reading operation is performed by keeping a predetermined distance between the reading portion 7 and the code 10, the image capturing is performed by the CCD camera 95 by generating the diffusion light by the light transmission member 27 before entering the reflection light to the CCD camera 95 in the illumination unit 8. Thus, for example, even when the code 10 is provided on the object with a mirror surface, the reading can be performed without causing the saturation of the CCD element by providing the light transmission member 27 between the CCD camera 95 and the reading portion 7. Accordingly, the reading of the code 10 may be performed even when receiving light that has been disturbed or altered.

On the other hand, when reading is performed keeping the distance between the code 10 and the coder reader 1, because the positional relationship with the camera focus point is determined with the minimum recognition distance L1, one of zero points in the recognition range by CCD element is to be determined. Thus, a recognizable region L2 may be determined to be a maximum recognition distance, which makes the recognition of the code 10 easy during the operation. In this case, an optimum focus position BP is located between the minimum recognition distance and the maximum recognition distance (BP is an intermediate position between the minimum recognition distance and the maximum recognition distance). Accordingly, the colored light from the light source 18 for the illumination may be arranged to cross with the optimum focus point distance BP at an intersection of the X-Y plane including the central axis from CCD camera. Thus, because the user may easily recognize the optimum reading position of the code reader 1 relative to the code 10 by the strength and the expansion of the light source 18 for the illumination, the reading of the code 10 may easily be performed.

Additionally, by removing the adjusting member 12 used for determining the minimum recognition distance L1 with the foregoing construction for directly covering the hood cover 5 on the hood portion 2a as shown in FIG. 12, the recognition distance for performing the code recognition may be further obtained by the thickness of the adjusting member 12 in the X-direction than the recognition distance L2 shown in FIG. 10. This enlarges the recognizable distance.

In this case, when the reading operation is performed accurately, the voltage buzzer 22 may be operated and the light source 24 for confirming the reading may be turned on by the main board 21. This enables the user to easily recognize the accurate reading of the code 10 by the code reader 1.

According to the non-limiting embodiments described above, because the code reader 1 may obtain the lens effect by the light transmission member 27, the recognizable range of the surface to be read on may be increased when compared to the case where a light transmission member 27 is not provided in the illumination unit.

Although the transparent light transmission member 27 may be applied with the foregoing non-limiting embodiment of the code reader of the present invention, the light transmission member 27 is not limited to the forgoing construction. For example, the light transmission member 27 may include some coloration, so long as the coloration does not largely decline the light permeability of the light transmission member 27. Once the light transmission member 27 receives the light, the light is reflected in the light transmission member 27, and the light is introduced to the surface to be read.

Further, although the light transmission member 27 obtained by cutting and by grinding the surface thereof is applied in the non-limiting embodiment, a resin molded light transmission member 27 may also be used. Furthermore, the light transmission member 27 may have a lens effect by injecting the liquid such as alcohol and the water or the like in the light transmission member 27, without using glass or resin or the like. In this case, in order to reduce the weight of the light transmission member 27, a light transmission member 27 made of acryl resin may be used.

According to another non-limiting embodiment of the present invention, because the light transmission member for introducing the light generated by the means for illuminating may be provided between the means for image capturing and the reading portion, the light generated by the means for illuminating may be diffused in the light transmission member, the diffused light may be introduced to the reading portion, and the surface to be read may be effectively illuminated with the diffused light.

As a result, the reading of the code can be performed by the reflection light contacting the code. Because the high luminance light is not entered into the means for image capturing by the light transmission member, the reading of the code provided on the mirror surface may be performed with a simple construction by providing the light transmission member between the means for image capturing and the reading portion.

In this case, the light transmission member may include a curved configured lens portion. By entering the light from the means for illumination to the lens portion with the curved configuration, the entered light may be effectively diffused into the light transmission member by the lens portion with the curved configuration.

By forming the lens portion on the both ends of the light transmission member and by crossing the light from means for illuminating to the light axis of means for image capturing, the irradiation range of the surface to be read may be increased, because the light entered with the light of the means for illuminating from the lens portion of the both ends of the light transmission member may irradiate the surface to be read with an extent from the reading portion.

Further, by providing the reflection surface for diffusing the light by reflecting the generated light from the means for illuminating to the inside of the light transmission member in the light transmission member, the light from the means for illuminating contacting the reflection surface is reflected on the inside of the light transmission member to easily produce the diffused light therein.

Still further, because the light transmission member may capture the image of the code based on the reflected light on the means for image capturing by enlarging the image of the code by the refraction of the light, the image of the code based on the reflected light captured by the means for image capturing may be easily recognized as code.

The light transmission member may effectively introduce the light to the reading portion, without leaking the light to the outside, by providing the light reflection membrane for preventing the leakage of the light other than the surface opposing to the reading portion and the means for image capturing on the light transmission member because the surfaces other than the surface opposing to the reading portion and the means for image capturing are covered with the light reflection membrane.

By applying transparent glass or resin to the light transmission member, the light transmission member with less fluid distortion and with high forthrightness is achieved to effectively introducing the light to the reading portion.

In this case, when the liquid is injected in the light transmission member, the les effect can be obtained by the liquid injected therein.

Further, by applying colored light to the means for illuminating for crossing the colored light at the focus point position of the means for image capturing, the reading position of the code is adjustable by observing the color of the illumination only by applying the colored illumination light.

The principles, preferred embodiment, and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A code reader comprising:
a housing;
a reading portion, provided at the housing, for reading a code provided on an object;
means, provided at the housing, for illuminating the code;
means, provided at the housing, for capturing an image of the code, wherein the means for illuminating the code may irradiate a light onto the code for reading information of the code by light reflected from the code; and
a light transmission means, provided between the means for capturing the image and the reading portion, for introducing the light generated by the means for illuminating.

2. The code reader according to claim 1, wherein the light transmission means includes a curved lens portion.

3. The code reader according to claim 2, wherein the lens portion is formed on both ends of the light transmission means, thereby causing the light from the means for illuminating to cross a light axis of the means for capturing the image.

4. The code reader according to claim 1, wherein the light transmission means includes a reflection surface for diffusing the light generated by the means for illuminating the code by reflecting light to the inside of the light transmission member.

5. The code reader according to claim 2, wherein the lens portion enlarges the image of the code by refraction of the light.

6. The code reader according to claim 1, wherein the light transmission means includes a light reflection membrane configured to prevent leakage of the light to an area other than a surface of the code opposite the reading portion and the means for capturing the image.

7. The code reader according to claim 1, wherein the light transmission means comprises at least one of transparent glass and resin.

8. The code reader according to claim 7, wherein the light transmission means includes a liquid portion.

9. The code reader according to claim 1, wherein the light from the means for illuminating the code includes colored light crossing a focal point of the means for capturing the image.

10. A code reader, comprising:
a housing;
a reading portion, provided at the housing, for reading a code provided on an object;
a light source provided at the housing and configured to illuminate the code;
a CCD camera provided at the housing for capturing an image of the code, wherein the light source is configured to irradiate a light onto the code for reading information of the code by light reflected from the code; and
a light transmission member provided between the CCD camera and the reading portion for introducing the light generated by the light source.

11. The code reader according to claim 10, wherein the light transmission member includes a curved lens portion.

12. The code reader according to claim 11, wherein the lens portion is formed on both ends of the light transmission member, thereby causing the light from the light source to cross toward a light axis of the CCD camera.

13. The code reader according to claim 10, wherein the light transmission member includes a reflection surface for diffusing the light generated by the light source.

14. The code reader according to claim 10, wherein the light transmission member enlarges the image of the code by refraction of the light.

15. The code reader according to claim 10, wherein the light transmission member includes a light reflection membrane configured to prevent leakage of the light to an area other than a surface of the code opposite the reading portion and the CCD camera.

16. The code reader according to claim 10, wherein the light transmission comprises at least one of transparent glass and resin.

17. The code reader according to claim 16, wherein the light transmission member includes a liquid portion.

18. The code reader according to claim 10, wherein the light from the light source includes colored light configured to cross a focal point of the CCD camera.

19. A method for reading a code, comprising:
reading the code using a code reader, the code reader comprising:
a housing;
a reading portion, provided at the housing, for reading a code provided on an object;
a light source provided at the housing and configured to illuminate the code;
a CCD camera provided at the housing for capturing an image of the code, wherein the light source is configured to irradiate a light onto the code for reading information of the code by light reflected from the code; and
a light transmission member provided between the CCD camera and the reading portion for introducing the light generated by the light source.
